(19) United States
(12) Patent Application Publication
(10) Pub. No.: US 2023/0360139 A1
(43) Pub. Date: Nov. 9, 2023

(54) COMPUTER-IMPLEMENTED METHOD AND SYSTEM FOR DYNAMICALLY ADJUSTING INSURANCE COVER AND AN INSURANCE PREMIUM

(71) Applicant: ONESPARK (PTY) LTD, Sandton Gauteng (ZA)

(72) Inventors: Francis Arthur GILL, Oaklands (ZA); Gregory Warren SMITH, Morningside (ZA); Josh Tana KAPLAN, Johannesburg (ZA)

(21) Appl. No.: 18/025,805

(22) PCT Filed: Sep. 15, 2021
(86) PCT No.: PCT/IB2021/058393

§ 371 Date: Mar. 10, 2023

(30) Foreign Application Priority Data
Sep. 16, 2020 (ZA) 202005735
Oct. 9, 2020 (ZA) 202006270

(51) Int. Cl. G06Q 40/08

(52) U.S. Cl. CPC G06Q 40/08

(57) ABSTRACT

A system for dynamically adjusting insurance cover and an insurance premium associated with a policy of a client includes at least one computer and a processor. The system calculates a first cover amount by assessing a financial need which would result from occurrence of an insured event during a first period. A first premium is based on the first cover amount. The system then uses adjusted policy data, at least some of which it automatically generates, applicable to a second period of the policy, to calculate a second cover amount by assessing a financial need which would result from occurrence of an insured event during the second period. A second premium is based on the second cover amount. In this way, the system dynamically updates and calculates a premium for each period of the policy based on the financial need of the client in that particular period.

This application claims priority to South African patent application number 2020/05735, filed on 16 Sep. 2020, and to South African patent application number 2020/06270, filed on 9 Oct. 2020, both of which are incorporated by reference herein.

### FIELD OF THE INVENTION

The invention relates to a computer-implemented method of dynamically adjusting insurance or risk cover and an insurance premium. The invention also relates to a system for dynamically adjusting insurance or risk cover and an insurance premium.

### BACKGROUND TO THE INVENTION

A review of the global life insurance industry reveals certain problems with traditional life insurance from the perspective of the modern consumer. On a fundamental level, despite a consumer's insurance needs varying over time, when the consumer takes out a traditional life insurance policy, the consumer is “locked” into a long-term contract based on his or her needs at that point in time.

Life insurers usually make an insurance cover proposal based primarily on a consumer's financial needs at one point in time, which is usually only when the policy is taken out. The cover associated with the life insurance policy then typically either remains constant (typically with a flat premium) or grows by a predefined percentage each year (typically with a premium that increases over time), regardless of changes in the consumer's needs.

Whether the consumer takes out a policy with a flat premium or a premium that increases by a fixed or gradually increasing percentage (e.g. by an age-related percentage), they will generally be penalised for correctly matching their needs—at inception and/or later on during their relationship with the insurer, as described below.

In the “flat premium” scenario, in most cases clients are effectively purchasing a portion of their future cover today by paying more to cover their future risk. The Inventors have found that this can be as much as twice or even more of what is required for the present-day cover of a particular client.

However, the modern consumer, e.g. a person which one could classify in the so-called “millennial” or “Generation Z” age bracket, may be unsure of what their financial needs will be in two years' time, let alone twenty or thirty years' time. They tend to move jobs, cities and countries frequently and resultantly their financial needs may change frequently. Accordingly, it could be viewed as unfair or unreasonable to require such a consumer to pay significantly more than what is required for present-day cover (so as to account for future cover in the short term) when they are not sure of what that their future cover needs will actually look like.

Additionally, and still referring to the “flat premium” scenario, if the client reduces cover near retirement to correctly account for reducing financial needs (e.g. debt that has been paid, lower expenses expected since children are independent, etc.), insurers can make large profits as these clients have overpaid for years for future cover they essentially never required or that never became applicable to them.

In the second scenario, i.e. a policy with a premium that increases by a fixed or gradually increasing percentage, often under the illusion of lower upfront premiums, clients are penalised for their loyalty later on in the policy term. The reason for this is that the longer they stay with an insurer, the higher their premium typically becomes. This is because insurers will overcharge at the later stages to make up for the lower upfront premiums. Therefore, clients who are most loyal and stay with the insurer the longest, may be penalised with large premium increases. Furthermore, clients who then correctly reduce their cover near retirement, as explained above, may be faced with loadings on their reduced premium to account for the “lost premiums” the insurer expected to earn.

According to the research and experience of the Inventors, these and other factors are creating an unsustainable life insurance industry, evidenced by many traditional insurers having to increase the premiums of their existing clients to either account for lower than expected lapses on their level book or higher than expected servicing reductions on their age-rated book. For purposes of this specification, “level book” is defined as a group of insurance policies where the premium increase is lower than the increase in risk, while “age-rated book” is defined as a group of insurance policies where the premium increase is in line with the increase in risk.

There is clearly a need to overcome these challenges and for a solution that better meets client needs on an ongoing basis. However, the Inventors have found that the technical systems currently used by insurers to calculate premiums and manage policies are deficient in that they are specifically configured to “penalise” clients by taking into account the factors explained above. In other words, the current technical systems used by insurance are unable to offer a client a premium that appropriately matches the life-stage of the client. As such there is a technical problem with known insurance systems. Embodiments of the present invention aim to provide a technical solution capable of addressing the above issue, at least to some extent, thereby not only to assist consumers in obtaining insurance that meets their needs, but to match those needs with an appropriate and fair premium at the various stages of a consumer's life and insurance journey.

### SUMMARY OF THE INVENTION

In accordance with a first aspect of the invention, there is provided a computer-implemented method of dynamically adjusting insurance cover and an insurance premium associated with a policy issued to a client by an insurer, the method comprising:
receiving and/or accessing, by at least one computer, policy data which includes client data and non-client data applicable to a first period of the policy;
calculating, by a processor associated with the at least one computer, a first cover amount based on the policy data, wherein the processor calculates the first cover amount by assessing a financial need which would result from the occurrence of an insured event during the first period;
calculating, by the processor, a first premium based on the first cover amount, wherein the first premium applies to the client during the first period;
receiving and/or accessing, by the at least one computer, adjusted policy data which includes adjusted client data and/or adjusted non-client data, wherein the adjusted policy data is applicable to a second period of the policy, and wherein the at least one computer automatically generates at least some of the adjusted policy data;
calculating, by the processor, a second cover amount based on the adjusted policy data, wherein the processor calculates the second cover amount by assessing a financial need which would result from the occurrence of an insured event during the second period; and
calculating, by the processor, a second premium based on the second cover amount, wherein the second premium applies to the client during the second period.

The method may include, in the absence of client input in respect of the policy data at or near the end of the first period, automatically generating all of the adjusted policy data required for the second period.

The first period may be a first year of the policy and the second period may be a second year of the policy. The method may include adjusting the cover amount and the premium for each period, e.g. each year, based on adjusted policy data for each particular period. The method may thus include carrying out similar steps in relation to a third period, fourth period, fifth period, and so forth, thereby to calculate a third premium, fourth premium, fifth premium, and so forth, in a dynamic manner.

The method may include calculating a monetary value associated with the financial need which would result from the occurrence of an insured event during each period. Calculation of this monetary value may be based on a number of variables forming part of the policy data, including but not limited to: client age, salary/income, tax payable now and in the future (changes in tax considerations over time), occupation, debt levels, existence and details of other life insurance plans, family composition and number of financial dependants, capital gain tax and other tax and liquidity requirements, investments and how investments (including investment mix) will change over time. The cover amount in each period may be equal to or based on the financial need determined for that period.

The step of receiving and/or accessing the adjusted policy data may include updating at least some of the variables forming part of the policy data.

The client data may include client input data. The non-client data may include economic data, third party data associated with the policy and/or regulatory data/considerations.

For each period, the premium may be calculated based on the cover amount required for that period, as well as at least some of: the client data, the non-client data, risk-specific client data, insurance-specific regulatory data, client experience data and insurer-specific data.

The policy may include, but is not limited to, one or more of: life cover, disability cover, income protection and/or illness cover. The insured event may thus be a qualifying event which would trigger a successful claim for life cover, disability cover, income protection and/or illness cover.

The method may include projecting at least some of the policy data forward to determine, in advance, adjusted policy data, cover amounts and/or premiums associated with future periods of the policy. The processor may be configured to execute a machine learning model which is trained to project at least some of the policy data forward.

The method may include generating, by the at least one computer, output indicative of the first premium or the second premium and transmitting the output to a communications device associated with the client.

The method may include generating, by the at least one computer, output indicative of the first cover amount or the second cover amount and transmitting the output to a communications device associated with the client.

In accordance with a second aspect of the invention, there is provided a system for dynamically adjusting insurance cover and an insurance premium associated with a policy of a client, the system comprising at least one computer and a processor, the system being configured to:
receive and/or access policy data which includes client data and non-client data applicable to a first period of the policy;
calculate, using the processor, a first cover amount based on the policy data, wherein the processor calculates the first cover amount by assessing a financial need which would result from the occurrence of an insured event during the first period;
calculate, using the processor, a first premium based on the first cover amount, wherein the first premium applies to the client during the first period;
receive and/or access adjusted policy data which includes adjusted client data and/or adjusted non-client data, wherein the adjusted policy data is applicable to a second period of the policy, and wherein the system is configured to generate at least some of the adjusted policy data automatically;
calculate, using the processor, a second cover amount based on the adjusted policy data, wherein the processor calculates the second cover amount by assessing a financial need which would result from the occurrence of an insured event during the second period; and
calculate, using the processor, a second premium based on the second cover amount, wherein the second premium applies to the client during the second period.

In accordance with a third aspect of the invention, there is provided a computer program product for dynamically adjusting insurance cover and an insurance premium, the computer program product comprising at least one computer-readable storage medium having program instructions embodied therewith, the program instructions being executable by at least one computer to cause the at least one computer to carry out the method substantially as described above. The computer-readable storage medium may be a non-transitory storage medium.

### BRIEF DESCRIPTION OF THE DRAWINGS

The invention will now be further described, by way of example, with reference to the accompanying drawings. In the drawings:

FIG. 1 is a schematic illustration of an embodiment of a system according to the invention;

FIG. 2 is a flow diagram illustrating certain steps and processes in an exemplary method according to the invention; and

FIG. 3 is a block diagram of an exemplary computer system capable of executing a computer program product to provide functions and/or actions according to at least some aspects of the invention.

### DETAILED DESCRIPTION WITH REFERENCE TO THE DRAWINGS

The following description is provided as an enabling teaching of the invention, is illustrative of principles associated with the invention and is not intended to limit the scope of the invention. Changes may be made to the embodiments depicted and described, while still attaining results of the present invention and/or without departing from the scope of the invention. Furthermore, it will be understood that some results or advantages of the present invention may be attained by selecting some of the features of the present invention without utilising other features. Accordingly, those skilled in the art will recognise that modifications and adaptations to the present invention may be possible and may even be desirable in certain circumstances, and may form part of the present invention.

Embodiments of the present invention provide a computerised system which is configured to adjust a client's insurance cover periodically, e.g. each year, to match their changed needs, thus ensuring that the client need only pay for what they require during each particular period. The system addresses technical problems associated with current systems typically used by insurers which do not assess needs based on life-stage of the client, and in particular which fail to assess needs based on changing life-stages of the client. Embodiments of the invention may utilise algorithms, such as machine learning algorithms, which dynamically track a client's needs over their life.

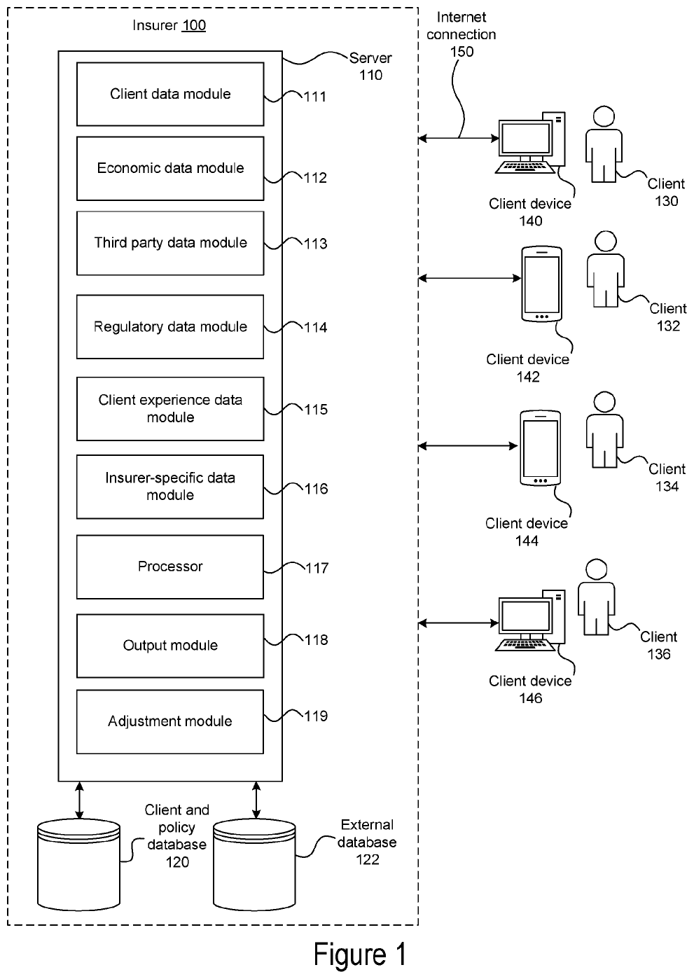

FIG. 1 shows a remotely accessible server (hereinafter “the server 110”) of an insurer 100. Insurance clients 130, 132, 134, 136 (including potential clients) are able to communicate with the insurer 100, e.g. via a suitable website or mobile application or other channels such as e-mail, in order to transmit information to and receive information from the server 110. It will be appreciated that these communications may be carried out for various purposes and over any suitable communications link, such as the Internet 150.

For purposes of this specification, the clients 130, 132, 134, 136 communicate with the insurer 100 in order to obtain quotes for and acquire (enter into agreements for) insurance products/policies, such as (but not limited to) life insurance and disability insurance. The clients 130, 132, 134, 136 may also periodically communicate with the insurer 100 to update certain data relating to their policies, e.g. provide updated personal and financial information on an annual basis, as will become apparent from the further descriptions below.

The clients 130, 132, 134, 136 may make use of any suitable communications devices in order to communicate with the insurer 100, and the client devices 140, 142, 144, 146 (mobile phones and personal computers with suitable connectivity) are shown as examples in FIG. 1. At least some aspects of the invention may also be implemented without requiring such a connection 150 between a client and the insurer 100, e.g. a client (not shown) may travel to a physical branch of the insurer 100 or meet with a financial advisor and provide the necessary input data to the insurer 100 at the branch or with the financial advisor, allowing cover and premiums to be calculated and adjusted as described in more detail below.

Typically, an insurance platform including a server like the server 110 in FIG. 1 may communicate with a large number of clients and third parties. However, for ease of reference and to illustrate aspects of the invention, an insurance policy interaction/transaction between the client 130 and the insurer 100 will be described below and reference will thus be made only to that particular client 130.

The server 110 may take various forms: it may include one or more computing devices and may be in a single location, distributed across various locations, hosted in a cloud-based environment, or combinations thereof.

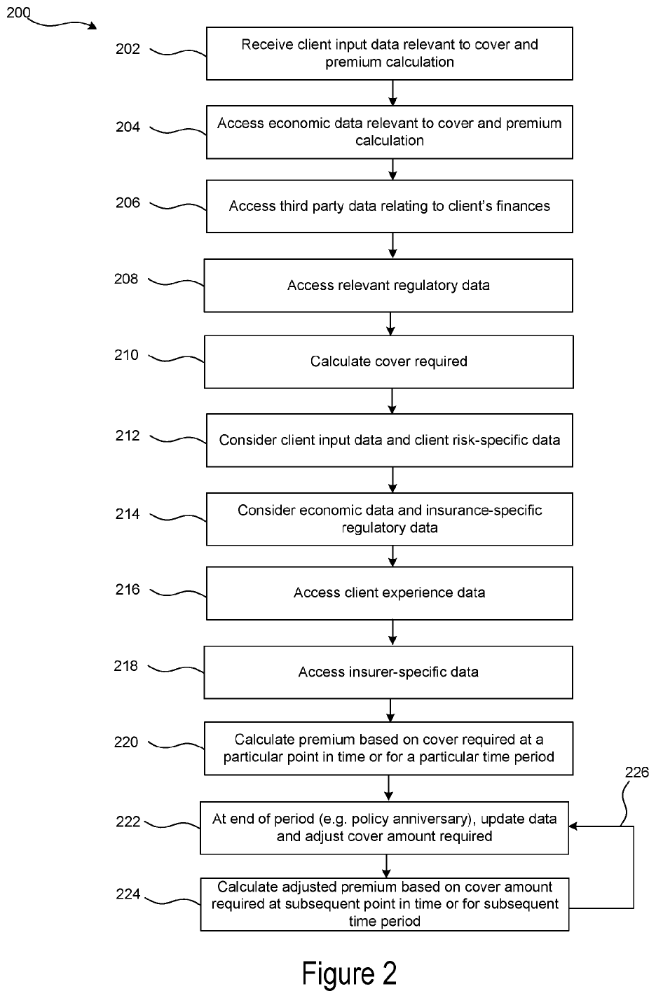

The server 110 includes a number of functional or logical components (referred to as “modules” below): a client data module 111, an economic data module 112, a third party data module 113, a regulatory data module 114, a client experience data module 115, an insurer-specific data module 116, a processor 117 (or multiple processors), an output module 118 and an adjustment module 119. The server 110 may, in practice, include many other functional/logical components, but the above modules 111-119 are focused on herein, again, to illustrate aspects of the invention. The configuration and functionality of the modules 111-119 are described in more detail with reference to the flow diagram 200 in FIG. 2 below.

The server 110 may also typically include, or be communicatively coupled to, a number of databases such as a client and policy database 120 with data internal to the insurer 100 and an external database 122 from which the insurer 100 draws external data, e.g. economic indicators, regulatory data, and the like.

The server 110 is specifically configured to implement an algorithm which, for each client, considers multiple variables to calculate the financial need at different ages or life stages and adjust their cover up or down (or remain the same) accordingly for each age/stage. This ensures that clients receive an optimal or near-optimal amount of cover to indemnify them should they suffer a qualifying life changing event. A system according to the invention may not only provide the appropriate amount of life cover, but also the appropriate amount of illness, income and/or disability cover required to meet their needs at each age/life stage.

The variables referred to above may, for instance, include the following: client age, salary/income, tax payable now (in current period) and in the future (changes in tax considerations over time), occupation, debt levels, existence and details of other life insurance plans, family composition and number of financial dependants, investments and how investments (including investment mix) will change over time.

The adjustment module 119 may be configured to re-assess and adjust these and other variables continuously or periodically. In some cases, the client 130 may manually update one or more of the variables.

Turning now to FIG. 2, which illustrates an example methodology, at a first stage 202, the client data module 111 receives client input data relevant to the calculation of a cover amount and premium for the policy. This may include the age of the client 130, number of dependents, retirement age, occupation, gross salary, and the like. In respect of occupation, the server 110 may specifically make use information such as qualifications, industry, location and work experience to calculate future expected changes to gross salary and tax without subsequent client input. The above information would typically be provided directly by the client 130.

At stage 204, the economic data module 112 receives or accesses economic data relevant to the calculation of the cover amount and premium. This may include data such as a risk-free rate, relationship between asset return and risk-free rate, implied inflation over time, and the like.

At stage 206, the third party data module 113 receives or accesses third party data (e.g. from an external database 122) so as to obtain an up to date view of certain details of the client 130, e.g. debt, spending, salary information, existing life insurance with other providers, and the like. In respect of debt, the server 110 may receive data relating to the split between short, medium and long-term debt and other specific debt information.

At stage 208, the regulatory data module 114 assesses regulatory considerations such as tax which would impact the finances of the client 130.

Then, at stage 210, the data described with reference to stages 202, 204, 206 and 208 above are used by the processor 117 to determine the amount of cover required by the client 130. The processor 117 may be configured specifically to determine the amount of cover required (to indemnify the client, as far as possible, against financial loss that would be suffered under the relevant events) for the present period, e.g. for the next year, and be further configured to do so on an ongoing/dynamic basis for subsequent periods, that is, without the client 130 having to input any updated values at a subsequent stage.

Once the processor 117 has calculated the amount of cover required for the period in question, it is necessary to determine the appropriate premium for that period. This is determined by assessing the occurrence of an insured event in the particular period only.

At stage 212, the client data module 111 accesses the client input data referred to above along with risk-specific client data, e.g. dangerous pursuits, health status, smoker status, and the like.

At stage 214, the economic data module 112 and regulatory data module 114 then access the economic data referred to above along with insurance-specific regulatory data, e.g. reserving requirements.

The client experience data module 115 and the processor 117 analyse data relating to client experience at stage 216. The client experience data may include experience indicators, which may include indicators of lapse experience, cancellation experience, mortality experience and/or morbidity experience, and the like. It will be appreciated that other experience indicators may be used and that the above are provided as examples. The processor 117 may be configured to analyse past experience data relating to the client experience indicator/s and future experience data relating to expected future changes in the client experience indicator/s in order to calculate the premium. The experience data may relate to instances, levels or rates of policy lapses, policy cancellations, client mortality and/or client morbidity, or data derived therefrom.

Then, at stage 218, insurer-specific data is accessed by the insurer-specific data module 116. This may be considerations specific to the insurer 100 such as absolute profit, profit emergence, expenses incurred, and the like.

At stage 220, the processor 117 then determines the appropriate premium for that particular period and suitable output is provided to the client 130 via the output module 118.

As mentioned above, the adjustment module 119 is configured to facilitate adjustment of the cover amount as required for subsequent periods, based on the changing needs of the client 130, and the premium is recalculated substantially as described above for subsequent periods (see stages 222, 224 and 226).

In this way, the server 110 is configured to determine the amount of insurance cover (life cover amount, disability cover amount, income protection amount and/or illness cover amount) the client 130 needs at each stage of their life. As mentioned above, the need is assessed against the specific event that occurs (e.g. loss of life represents loss of income to dependants who remain). This process may be employed continuously or periodically throughout the relationship with the client 130 so as to ensure the cover amount associated with the client 130 is adjusted as the client's needs change over time.

The current systems employed by most insurers have technical problems in this regard. In particular, a technical limitation is that the systems are specifically configured to consider risk across a number of periods and not in the current/given period. In embodiments of the invention, this technical problem is solved and the insurer 100 requires a charging structure that only considers the risk in a given period. In other words, the premium charged relates only to the current period in question and does not incorporate charges for funding future risk or which would require funding from the future for current risk. The Inventors have found that, advantageously, this could allow the insurer 100 to share any surplus related to an immediately preceding period, e.g. to share such surplus with clients.

In order to illustrate certain aspects of the invention in more detail, a specific, non-limiting example is provided below, again with reference to the client 130. South African Rand (R) is used as an exemplary currency to illustrate aspects of the invention.

In this example, the facts at onset of the policy are:
The client 130 is a 30 year old who earns R25 000 per month (gross salary) with one financial dependant (spouse).
The client 130 has a R1m home loan and a R200 000 car loan.
The client 130 is an accountant and plans to retire at age 65.

Based on data, x % (where x is less than 100% and dependent on number and type of dependents) of the client's income would be required by their spouse in the event of their death (100% required in the event of disability).

The algorithm employed by the server 110 projects forward their gross salary, allowing for age and occupation specific increases over and above implied inflation. These may be significantly higher at younger ages, e.g. for certain professionals like accountants. In different professions, increases or decreases as age increases may differ. The server 110 calculates their net salary allowing for changes in assumed taxation of personal income (based on historic changes in income tax as well as expected future tax changes).

Settlement of outstanding loans is allowed for and impacts the stream of “income” required for the period over which the loans were expected to be repaid.

This gives an accurate view of the amounts required at different points in time until retirement if an insured event occurs.

The algorithm then determines the most suitable investment strategy that will provide the required amounts throughout: it starts with an age based asset allocation between equity (high and low dividend yield shares), bonds (fixed and index linked government and corporate bonds), property (listed property shares) and money market, or the like. The asset allocation is then adjusted to ensure that no assets need to be disposed of in the first three years to meet any liquidity requirements (in order to ensure that any capital gains are taxed as such and not taxed as income).

The return provided by these assets (after the appropriate tax has been paid and investment fees allowed for) is used to provide for the abovementioned amounts at the different points in time (based on return implied by government bond prices and the relationship of the various different types of return of different assets to the risk free rate). The amount required is determined such that the portfolio runs down to retirement age (allowing for rebalancing of the portfolio based on age and to ensure sufficient liquidity is maintained).

In calculating the amount of cover required, the processor 117 may thus determine or access an age appropriate investment strategy (based on research of investment strategies and how they change based on age) allowing for the split of the client's asset pool between the main asset classes and within assets classes. The processor 117 may analyse future expected risk free rates (e.g. based on boot strapping government bonds based on their prices), the relationship between the risk free rate and return (income and capital gain) offered by different asset classes, the different applicable taxes (while adjusting the strategy appropriately to reduce and minimize tax as far as possible), and management of a client's exposure to asset volatility (set at an acceptable level to ensure the client 130 or their family do not run into liquidity constraints).

The premium (for the following 12 months) is then be determined based on this cover amount.

It will be appreciated that the above investment types, assets, tax details, etc. are examples only and various strategies and mixes can be employed by the system, depending on the implementation.

The dynamic nature of the cover requires premiums to be changed as the need of the client 130 changes over time. This ensures that the premium in any given year does not seem unreasonable relative to the cover provided, the specific individual's risk factors (age, gender, smoker status, income, occupation, health status, dangerous pursuits, family history, geographical location, etc.), economic assumptions, past experience, adjustment to allow for future expected differences in experience, regulatory considerations (impact of reserving requirements, specific taxation depending on policy classification, etc.) and company specific requirements (e.g. profit required, expenses incurred, profit emergence, etc.).

At policy anniversary, the adjustment module 119 adjusts the necessary client, economic and other details. If the client 130 does not manually update any information previously provided (and where information is not available from a third party), their gross salary would be projected forward using age and occupation (this may be expanded to include variables such as industry, location and others). The loan amounts would be run down based on the loan details if exact balances cannot be retrieved from another party. Tax assumptions would typically be updated and risk free rates (and the relationship of asset return to risk free rates) would also be updated.

A new cover amount, or a difference/change in cover amount, is then determined by the processor 117, using the steps already described above, for the new period. Again, the premium for the new period would be determined as described above using the updated data and revised cover amount. This system thus offers a technical solution allowing for the implementation of an insurance policy in which the client is no longer “locked” into a long term, static contract as implemented by current technical systems, but essentially receives a dynamic short term contract where their cover automatically adjusts each year.

It is envisaged that numerous changes may be made to the embodiments described above without departing from the scope of the invention. For instance, the algorithm referred to above may incorporate certain learning aspects to facilitate the accurate and automatic updating of the cover amount and premium.

For example, the processor 117 may be configured to execute a machine learning model which has been trained to project at least some of the variables used to calculate the required cover in future periods forward. This may include learning how salary adjusts based on various identifiable factors, how financial dependants change and how the income requirement changes depending on the number of dependents and their roles (e.g. based on individual spend), how benefit amounts paid are used after claims and how this changes over time, e.g. some sort of adjustment period before spending returns to “normal”, and the like.

Embodiments of the invention thus provide a computerised, technical insurance product solution providing numerous advantages. Some of these advantages have already been identified above, and others are described below.

The technical systems currently used by insurers to calculate premiums and manage policies are often deficient in that they are configured to rely on cross-subsidies when automatically calculating, processing and managing policy related data. This technical problem is solved by embodiments, as they may reduce or eliminate cross-subsidies. This means that the premium a client pays may actually be equal or substantially equal to their risk cost at each age/life stage. The removal of these cross-subsidies, meaning that a client only pays for their current risk at each age and not their or others' risk at a different time, may permit a more sustainable life insurance model in which clients can increase or decrease their cover at future points without penalties or loadings.

Embodiments of the invention may allow the insurer to utilise a relatively small fee to cover what it needs to run its business. The rest of the available funds may be pooled to cover any claims that arise and the surplus may even be returned to clients in some instances, enabling a peer-to-peer life insurance model.

Embodiments of the invention offer a simple solution, requiring minimal input from the client despite providing a personalised, needs-matched solution to their financial needs every year. It ensures that they are not over-insured as they approach retirement and not under-insured during their earlier working life, in case they experience a life-changing event.

The system is specifically configured to determine cover that is appropriate for the needs of clients through all stages of life, instead of using needs at a point in time and simply increasing these by inflation or having to re-assess needs regularly on a manual basis, e.g. through a financial advisor.

Embodiments of the invention may leverage intelligent algorithms and technology that take into account future salaries, tax considerations, life stage, occupation and family structures, among others, to ensure that clients are appropriately protected. The system is robust in the sense that it takes into account risks such as those associated with asset volatility through ensuring sufficient liquidity.

The invention may also provide a more fair and unbiased model, as products meet the actual financial needs of clients and do not incorporate loadings or penalties to account for the behaviour of other clients or behaviour of the particular client far into the future.

In some embodiments, the system may allow the client to tailor their cover to their unique financial situation. In such cases the client may specify how much they can afford, with the algorithm essentially working “backwards” to provide optimal or near-optimal protection for the given premium.

To the best of the Inventors' knowledge and belief, the actuarial pricing mechanisms underpinning embodiments of the invention have never been utilised before and the structural change in the manner in which life insurance is priced and designed, as described herein, may create societal value in the form of significantly lower premiums.

The Inventors' have found that embodiments of the invention may provide premium savings of as much as 50% or even more, allowing clients to take out more cover for the same premium or making previously unaffordable products affordable to certain consumers. The invention may thus assist in closing the so-called “life insurance gap” in terms of which many individuals worldwide are not covered or not adequately covered.

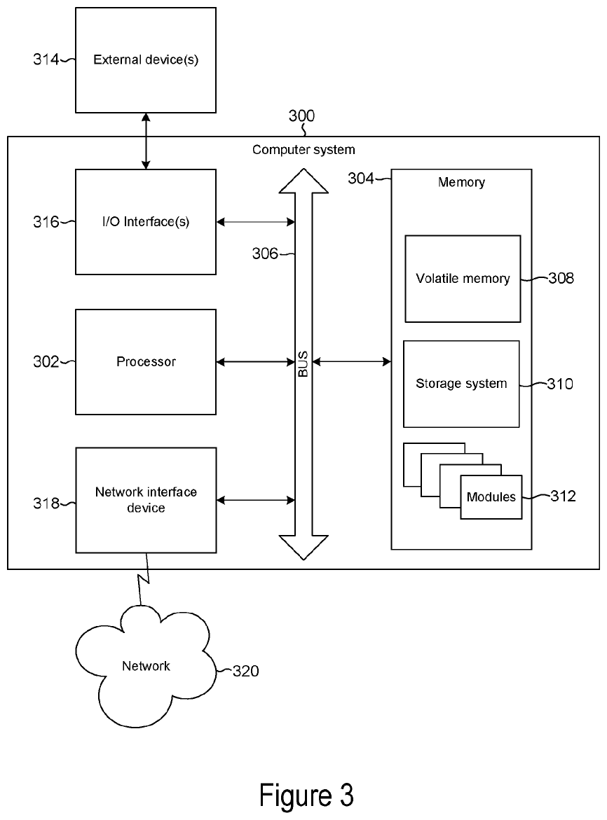

The techniques described above may be implemented in or using one or more computer systems, such as the computer system 300 shown in FIG. 3. The computer system 300 may be or include any suitable computer or server. The server 110 may include such a computer system 300. The computer system 300 may be implemented in distributed cloud computing environments where tasks are performed by remote processing devices that are linked through a communications network. In a distributed cloud computing environment, program modules executed by the computer system 300 may be located both locally and remotely.

In the example shown in FIG. 3, the computer system 300 has features of a general-purpose computer. These components may include, but are not limited to, at least one processor 302, a memory 304 and a bus 306 that couples various components of the system 300 including the memory 304 to the processor 302. The bus 306 may have any suitable type of bus structure. The computer system 300 may include one or more different types of readable media, such as removable and non-removable media and volatile and non-volatile media.

The memory 304 may thus include volatile memory 308 (e.g. random access memory (RAM) and/or cache memory) and may further include other storage media such as a storage system 310 configured for reading from and writing to a non-removable, non-volatile media such as a hard drive. It will be understood that the computer system 300 may also include or be coupled to a magnetic disk drive and/or an optical disk drive (not shown), and/or any other suitable type of drive, for reading from or writing to suitable non-volatile media. These may be connected to the bus 306 by one or more data media interfaces.

The memory 304 may be configured to store program modules 312. The modules 312 may include, for instance, an operating system, one or more application programs, other program modules, and program data, each of which may include an implementation of a networking environment. The components of the computer system 300 may be implemented as modules 312 which generally carry out functions and/or methodologies of embodiments of the invention as described herein. It will be appreciated that embodiments of the invention may include or be implemented by a plurality of the computer systems 300, which may be communicatively coupled to each other.

The computer system 300 may operatively be communicatively coupled to at least one external device 314. For instance, the computer system 300 may communicate with external devices 314 in the form of a modem, keyboard and display. These communications may be effected via suitable Input/Output (I/O) interfaces 316.

The computer system 300 may also be configured to communicate with at least one network 320 (e.g. the Internet or a local area network) via a network interface device 318/network adapter. The network interface device 318 may communicate with the other elements of the computer system 310, as described above, via the bus 306.

The components shown in and described with reference to FIG. 3 are examples only and it will be understood that other components may be used as alternatives to or in conjunction with those shown.

Aspects of the present invention may be embodied as a system, method and/or computer program product. Accordingly, aspects of the present invention may take the form of hardware, software and/or a combination of hardware and software that may generally be referred to herein as “components”, “units”, “modules”, “systems”, “elements”, or the like.

Furthermore, aspects of the present invention may take the form of a computer program product embodied in one or more computer-readable storage medium having computer-readable program code embodied thereon. A computer-readable storage medium may, for instance, be an electronic, magnetic, optical, electromagnetic, infrared, or semiconductor system, apparatus, or device, or any suitable combination of the above. In the context of this specification, a computer-readable storage medium may be any suitable medium capable of storing a program for execution or in connection with a system, apparatus, or device. Program code/instructions may execute on a single device, on a plurality of devices (e.g., on local and remote devices), as a single program or as part of a larger system/package.

The present invention may be carried out on any suitable form of computer system, including an independent computer or processors participating on a network of computers. Therefore, computer systems programmed with instructions embodying methods and/or systems disclosed herein, computer systems programmed to perform aspects of the present invention and/or media that store computer-readable instructions for converting a general purpose computer into a system based upon aspects of the present invention, may fall within the scope of the present invention.

Chart(s) and/or diagram(s) included in the figures illustrate examples of implementations of one or more system, method and/or computer program product according to one or more embodiment(s) of the present invention. It should be understood that one or more blocks in the figures may represent a component, segment, or portion of code, which comprises one or more executable instructions for implementing specified logical function(s). In some alternative implementations, the actions or functions identified in the blocks may occur in a different order than that shown in the figures or may occur concurrently.

It will be understood that blocks or steps shown in the figures may be implemented by system components or computer program instructions. Instructions may be provided to a processor of any suitable computer or other apparatus such that the instructions, which may execute via the processor of the computer or other apparatus, establish or generate means for implementing the functions or actions identified in the figures.

1. A computer-implemented method of dynamically adjusting insurance cover and an insurance premium associated with a policy issued to a client by an insurer, the method comprising:
receiving and/or accessing, by at least one computer, policy data which includes client data and non-client data applicable to a first period of the policy;
calculating, by a processor associated with the at least one computer, a first cover amount based on the policy data, wherein the processor calculates the first cover amount by assessing a financial need which would result from occurrence of an insured event during the first period;
calculating, by the processor, a first premium based on the first cover amount, wherein the first premium applies to the client during the first period;
receiving and/or accessing, by the at least one computer, adjusted policy data which includes adjusted client data and/or adjusted non-client data, wherein the adjusted policy data is applicable to a second period of the policy, and wherein the at least one computer automatically generates at least some of the adjusted policy data;
calculating, by the processor, a second cover amount based on the adjusted policy data, wherein the processor calculates the second cover amount by assessing a financial need which would result from occurrence of an insured event during the second period;
calculating, by the processor, a second premium based on the second cover amount, wherein the second premium applies to the client during the second period; and
generating, by the at least one computer, output indicative of the first premium or the second premium and transmitting the output to a communications device associated with the client.

2. The method according to claim 1, wherein the method includes, in the absence of client input in respect of the policy data at or near the end of the first period, automatically generating all of the adjusted policy data required for the second period.

3. The method according to claim 1, which includes projecting, by the processor, at least some of the policy data forward to determine, in advance, adjusted policy data, cover amounts and/or premiums associated with future periods of the policy.

4. The method according to claim 3, wherein the processor is configured to execute a machine learning model which is trained to project at least some of the policy data forward.

5. The method according to claim 1, wherein the first period is a first year of the policy and the second period is a second year of the policy, the method including dynamically adjusting, by the processor, the cover amount and the premium for each period based on adjusted policy data for each particular period.

6. The method according to claim 1, which includes calculating, by the processor, a monetary value associated with the financial need which would result from the occurrence of an insured event during each period, such that the cover amount in each period is equal to or based on the financial need determined for that period.

7. The method according to claim 6, wherein the calculation of the monetary value is based on a plurality of variables forming part of the policy data, including a plurality of the following: client age, client salary, client income, tax payable in current period, tax payable in future, changes in tax considerations over time, occupation, debt levels, existence and details of other insurance plans, family composition, number of financial dependants, investment mix, and how investment mix will change over time.

8. The method according to claim 7, wherein receiving and/or accessing the adjusted policy data includes updating at least some of the variables forming part of the policy data.

9. The method according to claim 1, wherein the insured event is a qualifying event which would trigger a successful claim for life cover, disability cover, income protection and/or illness cover.

10. A system for dynamically adjusting insurance cover and an insurance premium associated with a policy of a client, the system comprising at least one computer and a processor, the system being configured to:
receive and/or access policy data which includes client data and non-client data applicable to a first period of the policy;
calculate, using the processor, a first cover amount based on the policy data, wherein the processor calculates the first cover amount by assessing a financial need which would result from occurrence of an insured event during the first period;
calculate, using the processor, a first premium based on the first cover amount, wherein the first premium applies to the client during the first period;
receive and/or access adjusted policy data which includes adjusted client data and/or adjusted non-client data, wherein the adjusted policy data is applicable to a second period of the policy, and wherein the system is configured to generate at least some of the adjusted policy data automatically;
calculate, using the processor, a second cover amount based on the adjusted policy data, wherein the processor calculates the second cover amount by assessing a financial need which would result from occurrence of an insured event during the second period;
calculate, using the processor, a second premium based on the second cover amount, wherein the second premium applies to the client during the second period; and
generate, by the at least one computer, output indicative of the first premium or the second premium and transmit the output to a communications device associated with the client.

11. The system according to claim 10, wherein the system is configured such that, in the absence of client input in respect of the policy data at or near the end of the first period, the processor automatically generates all of the adjusted policy data required for the second period.

12. The system according to claim 10, wherein the processor is configured to project at least some of the policy data forward to determine, in advance, adjusted policy data, cover amounts and/or premiums associated with future periods of the policy.

13. The system according to claim 12, wherein the processor is configured to execute a machine learning model which is trained to project at least some of the policy data forward.

14. The system according to claim 10, wherein the first period is a first year of the policy and the second period is a second year of the policy, the processor being configured to adjust the cover amount and the premium dynamically for each period based on adjusted policy data for each particular period.

15. The system according to claim 10, wherein the processor is configured to calculate a monetary value associated with the financial need which would result from the occurrence of an insured event during each period, such that the cover amount in each period is equal to or based on the financial need determined for that period.

16. The system according to claim 15, wherein the calculation of the monetary value is based on a plurality of variables forming part of the policy data, including a plurality of the following: client age, client salary, client income, tax payable in current period, tax payable in future, changes in tax considerations over time, occupation, debt levels, existence and details of other insurance plans, family composition, number of financial dependants, investment mix, and how investment mix will change over time.

17. The system according to claim 16, wherein receiving and/or accessing the adjusted policy data includes updating at least some of the variables forming part of the policy data.

18. The system according to claim 10, wherein the insured event is a qualifying event which would trigger a successful claim for life cover, disability cover, income protection and/or illness cover.
